(19) United States
(12) Patent Application Publication
(10) Pub. No.: US 2014/0331187 A1
(43) Pub. Date: Nov. 6, 2014

(54) GROUPING OBJECTS ON A COMPUTING DEVICE

(71) Applicant: BARNESANDNOBLE.COM LLC, New York, NY (US)

(72) Inventors: Kourtny M. Hicks, Sunnyvale, CA (US); Gerald B. Cueto, San Jose, CA (US); Amir Mesguich Havilio, Palo Alto, CA (US)

(73) Assignee: barnesandnoble.com llc, New York, NY (US)

(21) Appl. No.: 13/886,777

(22) Filed: May 3, 2013

(51) Int. Cl. G06F 3/0488

(52) U.S. Cl. CPC G06F 3/0488
USPC 715/845

(57) ABSTRACT

Techniques are disclosed for providing a group mode in a computing device to group objects (e.g., files, photos, etc.) displayed and/or stored on the computing device into a bundle. The group mode can be invoked in response to a swipe gesture, a press-and-hold gesture, and/or other user input indicative that the group mode is desired. The user may interact with the bundle once it is formed, including sharing or organizing the bundle as desired, for example. In some cases, the user input used to invoke the group mode may also be used to invoke a bundle interaction, such as to group and share the bundle using a single swipe gesture. In some cases, the user may be able to select the objects desired to be grouped and cause them to be grouped into a bundle using the same user input, such as one continuous swipe gesture.

### FIELD OF THE DISCLOSURE

This disclosure relates to computing devices, and more particularly, to user interface (UI) techniques for grouping multiple objects (e.g., files, photos, etc.) on a computing device.

### BACKGROUND

Computing devices such as tablets, eReaders, mobile phones, smart phones, personal digital assistants (PDAs), and other such devices are commonly used for displaying consumable content. The content may be, for example, an eBook, an online article or website, images, documents, a movie or video, or a map, just to name a few types. Such display devices are also useful for displaying a user interface that allows a user to interact with the displayed content. The user interface may include, for example, one or more touch screen controls and/or one or more displayed labels that correspond to nearby hardware buttons. Some computing devices are touch sensitive and the user may interact with touch sensitive computing devices using fingers, a stylus, or other implement. Touch sensitive computing devices may include a touch screen, which may be backlit or not, and may be implemented for instance with an LED screen or an electrophoretic display. Such devices may also include other touch sensitive surfaces, such as a track pad (e.g., capacitive or resistive touch sensor).

### BRIEF DESCRIPTION OF THE DRAWINGS

FIGS. 1a-b illustrate an example computing device having a group mode configured in accordance with an embodiment of the present invention.

FIGS. 1c-d illustrate example configuration screen shots of the user interface of the computing device shown in FIGS. 1a-b configured in accordance with an embodiment of the present invention.

FIG. 2a illustrates a block diagram of a computing device configured in accordance with an embodiment of the present invention.

FIG. 2b illustrates a block diagram of a communication system including the computing device of FIG. 2a configured in accordance with an embodiment of the present invention.

FIG. 3a illustrates a screen shot of an example computing device having a group mode configured in accordance with one or more embodiments of the present invention.

FIGS. 3b-b′ illustrate an example user input used to group preselected objects into a bundle, in accordance with an embodiment of the present invention.

FIGS. 3c-c′″ illustrate an example group mode configuration where holding user input used to group objects performs an action, in accordance with an embodiment of the present invention.

FIGS. 3d-d′″ illustrate an example user input used to group preselected objects into a bundle and perform an interaction on the bundle, in accordance with an embodiment of the present invention.

FIGS. 3e-e′ illustrate an example user input used to select objects and group the selected objects into a bundle, in accordance with an embodiment of the present invention.

FIGS. 3f-f′ illustrate an example user input used to ungroup a previously formed bundle, in accordance with an embodiment of the present invention.

FIGS. 3g-g′ illustrate an example user input used to group preselected objects into a bundle, in accordance with an embodiment of the present invention.

FIG. 4 illustrates a method for providing a group mode in a computing device, in accordance with an embodiment of the present invention.

### DETAILED DESCRIPTION

Techniques are disclosed for providing a group mode in a computing device to group objects (e.g., files, photos, etc.) displayed and/or stored on the computing device into a bundle. The group mode can be invoked in response to a swipe gesture, a press-and-hold gesture, and/or other user input indicative that the group mode is desired. Once objects are grouped into a bundle, the bundle may be grouped with additional objects or other bundles. Bundles may be ungrouped using an ungroup action, such as a spread gesture performed on a previously formed bundle, for example. The user may interact with the bundle once it is formed, including sharing or organizing the bundle as desired. For example, after objects, such as virtual books, are preselected, a user can group them into a bundle using a press-and-hold gesture. The bundle of virtual books can be moved using a drag-and-drop gesture from a first location (e.g., Course A) to a second location (e.g., Course B). Upon dropping the bundle of virtual books on Course B, the bundle may automatically ungroup in their new location to allow the virtual books to be seen in Course B. In some cases, the user input used to invoke the group mode may also be used to invoke a bundle interaction simultaneously, such as to group and share the bundle using a single swipe gesture. In some cases, the user may be able to select the objects desired to be grouped and cause them to be grouped into a bundle using the same user input, such as one continuous swipe gesture. Numerous other configurations and variations will be apparent in light of this disclosure.

General Overview

As previously explained, computing devices such as tablets, eReaders, and smart phones are commonly used for displaying user interfaces and consumable content. In some instances, the user of the device may desire to interact with a group of objects (such as pictures, contacts, or notes) being displayed and/or stored on the device. Interactions may include editing, organizing, or sharing the group of objects. For example, the user may desire to move a group of photos from one folder to another or organize groups of photos within a folder. While computing devices may provide techniques for performing various interactions involving two or more selected objects, the user has to re-select the objects individually each time an interaction with that group of objects is desired, leading to a diminished user experience.

Thus, and in accordance with one or more embodiments of the present invention, techniques are disclosed for grouping objects displayed and/or stored on a computing device into bundles in response to user input, referred to collectively herein as a group mode. As will be apparent in light of the present disclosure, various user input can be used to invoke the group mode, such as a swipe gesture or a press-and-hold gesture, for example. The objects that may be grouped using a group mode may include files, pictures, video content, audio content, books, drawings, messages, notes, documents, presentations or lectures, pages, folders, icons, textual passages, bookmarks, calendar events, contacts, applications, services, configuration settings, and previously formed bundles, just to name some examples. As will be apparent in light of this disclosure, the bundle may be represented in various ways, such as in a stack or a folder, for example.

In some embodiments, object selection may occur prior to invoking the group mode. For example, in some such embodiments, the user may select all of the objects on the device desired to be grouped (e.g., using appropriately placed taps when in a selection mode) and then invoke the group mode as described herein (e.g., using a swipe gesture or press-and-hold gesture) to group those preselected objects into a bundle. In other embodiments, the same user input may be used to both select objects desired to be bundled and then group those selected objects into a bundle, referred to herein as a select plus group function. For example, in some such embodiments, a select plus group function may include a swipe gesture that selects objects by swiping around each object desired to be grouped using one continuous gesture. In such an example, the selected objects can be grouped into a bundle upon releasing the gesture. More specifically, the user may be able to swipe around individual objects to select them and then those selected objects can be grouped into a bundle when the gesture is released.

Once multiple objects have been bundled, the user may interact with the bundle as though it is one entity, which may allow for easier organizing, editing, or sharing, for example. In this way, the group mode functions disclosed herein can be used to enhance the user experience when interacting with two or more objects, particularly when dealing with computing devices that use a small touch screen and have limited display space, such as smart phones, eReaders, and tablet computers. In some embodiments, the interactions available to be performed on the bundle may depend upon the type of objects bundled and/or the capabilities of the computing device. For example, performing a red eye reduction editing interaction may be appropriate on a bundled group of pictures, but may not be appropriate on a bundled group of documents. Further, the red eye reduction editing interaction may only be available in devices having such capabilities.

In some embodiments, the same user input may be used to both group preselected objects into a bundle and to invoke an interaction to be performed on the bundle, referred to herein as a group plus interaction function. For example, after objects desired to be bundled have been preselected by a user (e.g., using appropriately placed taps when in a selection mode), the user may invoke a group plus interaction function using a swipe gesture. In such an example, the direction of the swipe gesture may determine whether to invoke a bundle interaction. More specifically, a downward swipe may be used to group the objects into a bundle, a leftward swipe may be used to group the objects into a bundle and share the bundle, a rightward swipe may be used to group the objects into a bundle and email the bundle, and an upward swipe may be used to group the objects into a bundle and copy the bundle, for example.

Some embodiments of the group mode may allow the grouping of different types of objects, as will be apparent in light of this disclosure. For example, in some such embodiments, a user may wish to group selected pictures and videos into one bundle to simplify sharing the contents of the bundle. In some embodiments, once an interaction is performed on a bundle, the bundle may be ungrouped. For example, in some such embodiments, after a bundle of objects is moved from a first location to a second location (e.g., using a drag-and-drop gesture), the objects in the bundle may ungroup automatically, i.e., after moving them to the second location. In some embodiments, the group mode may include a function to ungroup a previously formed bundle. For example, in some such embodiments, a press-and-hold gesture, outward spread gesture, or double-tap gesture performed on the bundle may be used to ungroup a previously formed bundle, as will be discussed in turn.

In some embodiments, the functions performed when using a group mode as variously described herein may be configured at a global level (i.e., based on the UI settings of the electronic device) and/or at an application level (i.e., based on the specific application being displayed). To this end, the group mode may be user-configurable in some cases, or hard-coded in other cases. Further, the group mode as variously described herein may be included initially with the UI (or operating system) of a computing device or be a separate program/service/application configured to interface with the UI of a computing device to incorporate the functionality of the group mode as variously described herein. In the context of embodiments where the computing device is a touch sensitive computing device, user input (e.g., the input used to make group mode swipe gestures) is sometimes referred to as contact or user contact for ease of reference. However, direct and/or proximate contact (e.g., hovering within a few centimeters of the touch sensitive surface) may be used to perform the gestures variously described herein depending on the specific touch sensitive device/interface being used. In other words, in some embodiments, a user may be able to use the group mode without physically touching the computing device or touch sensitive interface, as will be apparent in light of this disclosure.

### Device and Configuration Examples

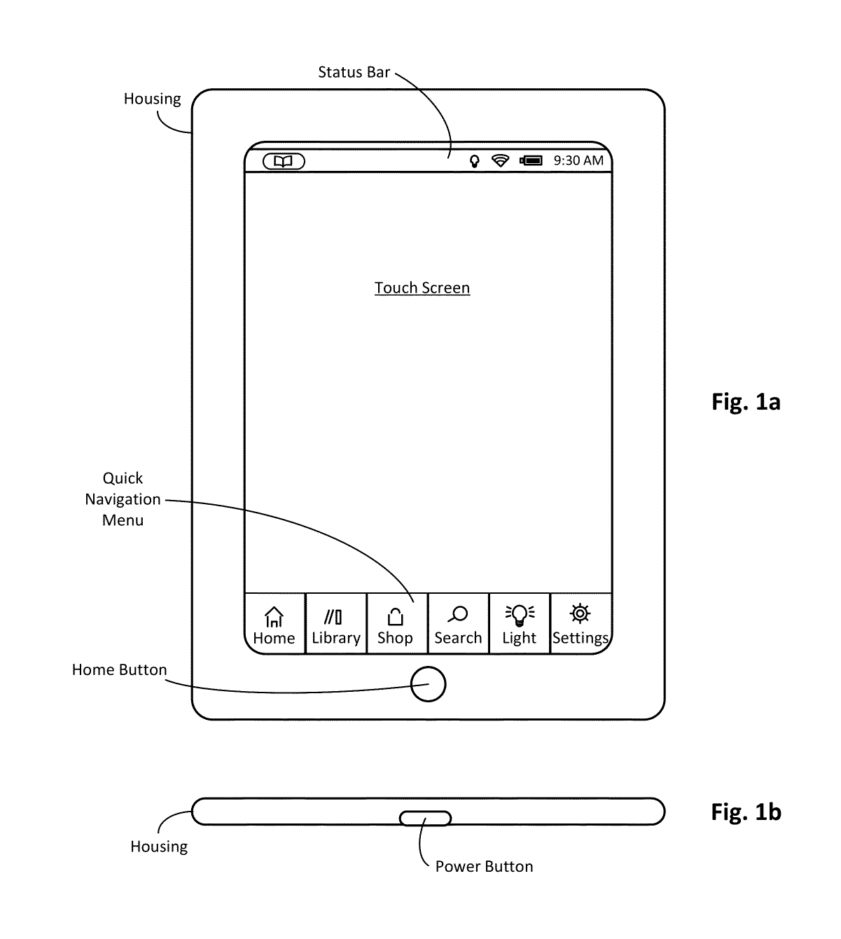

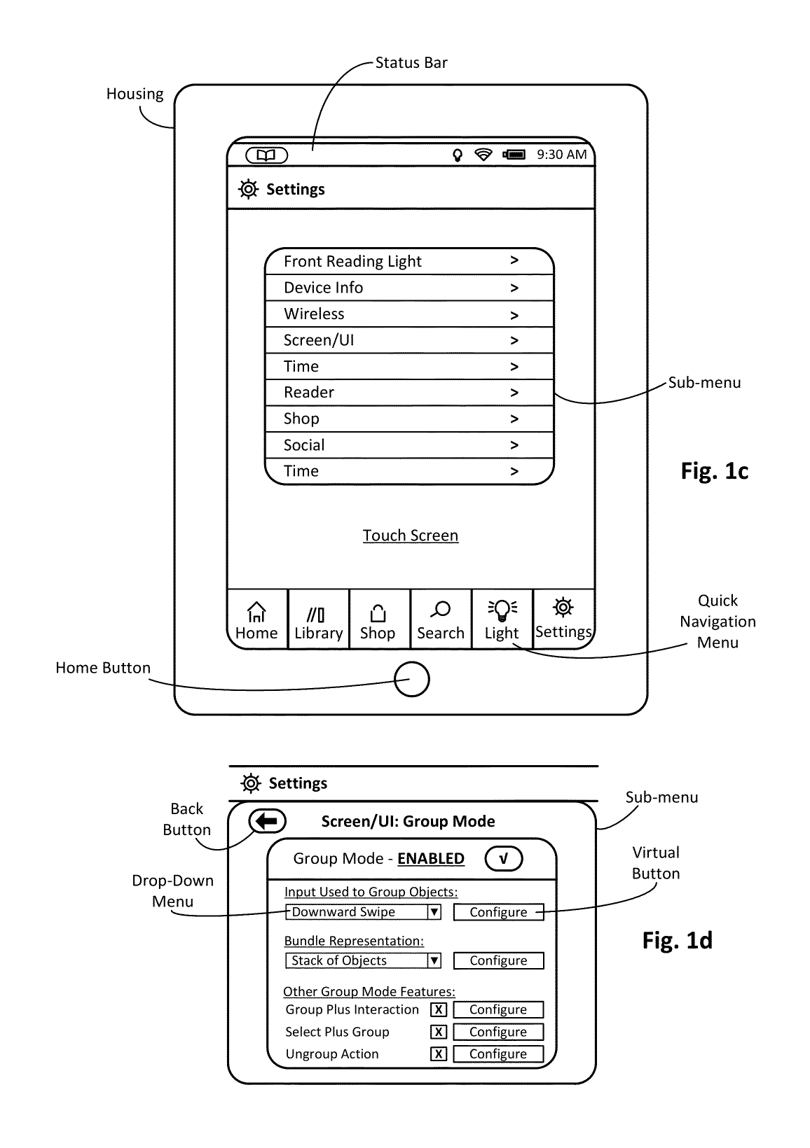

FIGS. 1a-b illustrate an example computing device having a group mode configured in accordance with an embodiment of the present invention. The device could be, for example, a tablet such as the NOOK® Tablet by Barnes & Noble. In a more general sense, the device may be any computing device, whether touch sensitive (e.g., where input is received via a touch screen, track pad, etc.) or non-touch sensitive (e.g., where input is received via a physical keyboard and mouse), such as an eReader, a tablet or laptop, a desktop computing system, a television, a smart display screen. For ease of description, the techniques used for grouping objects on a computing device will be discussed herein in the context of touch sensitive computing devices. As will be appreciated in light of this disclosure, the claimed invention is not intended to be limited to any particular kind or type of computing device.

As can be seen with the example computing device shown in FIGS. 1a-b, the device comprises a housing that includes a number of hardware features such as a power button and a press-button (sometimes called a home button herein). A touch screen based user interface (UI) is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI touch screen controls and features, or different UI touch screen controls and features altogether, depending on the target application of the device. Any such general UI controls and features can be implemented using any suitable conventional or custom technology, as will be appreciated.

The power button can be used to turn the device on and off, and may be used in conjunction with a touch-based UI control feature that allows the user to confirm a given power transition action request (e.g., such as a slide bar or tap point graphic to turn power off). In this example configuration, the home button is a physical press-button that can be used as follows: when the device is awake and in use, tapping the button will display the quick navigation menu, which is a toolbar that provides quick access to various features of the device. The home button may also be configured to unselect preselected objects or ungroup a recently formed bundle, for example. Numerous other configurations and variations will be apparent in light of this disclosure, and the claimed invention is not intended to be limited to any particular set of buttons or features, or device form factor.

As can be further seen, the status bar may also include a book icon (upper left corner). In some such cases, the user can access a sub-menu that provides access to a group mode configuration sub-menu by tapping the book icon of the status bar. For example, upon receiving an indication that the user has touched the book icon, the device can then display the group mode configuration sub-menu shown in FIG. 1d. In other cases, tapping the book icon may just provide information on the content being consumed. Another example way for the user to access a group mode configuration sub-menu such as the one shown in FIG. 1d is to tap or otherwise touch the Settings option in the quick navigation menu, which causes the device to display the general sub-menu shown in FIG. 1c. From this general sub-menu the user can select any one of a number of options, including one designated Screen/UI in this specific example case. Selecting this sub-menu item (with, for example, an appropriately placed screen tap) may cause the group mode configuration sub-menu of FIG. 1d to be displayed, in accordance with an embodiment. In other example embodiments, selecting the Screen/UI option may present the user with a number of additional sub-options, one of which may include a so-called group mode option, which may then be selected by the user so as to cause the group mode configuration sub-menu of FIG. 1d to be displayed. Any number of such menu schemes and nested hierarchies can be used, as will be appreciated in light of this disclosure.

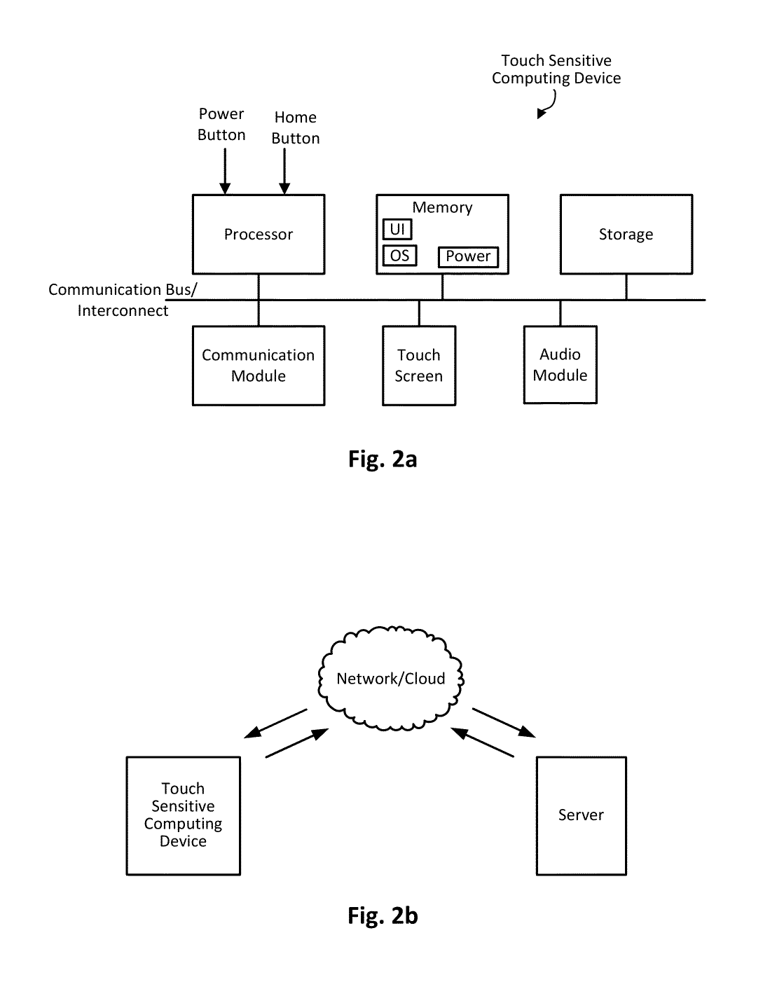

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates the user touch in a given location into an electrical signal which is then received and processed by the underlying operating system (OS) and circuitry (processor, etc.). Additional example details of the underlying OS and circuitry in accordance with some embodiments will be discussed in turn with reference to FIG. 2a. In some cases, the group mode may be automatically configured by the specific UI or application being used. In these instances, the group mode need not be user-configurable (e.g., if the group mode is hard-coded or is otherwise automatically configured).

As previously explained, and with further reference to FIGS. 1c and 1d, once the Settings sub-menu is displayed (FIG. 1c), the user can then select the Screen/UI option. In response to such a selection, the group mode configuration sub-menu shown in FIG. 1d can be provided to the user. In this example case, the group mode configuration sub-menu includes a UI check box that when checked or otherwise selected by the user, effectively enables the group mode (shown in the Enabled state); unchecking the box disables the mode. Other embodiments may have the group mode always enabled, or enabled by a switch or button, for example. In some instances, the group mode may be automatically enabled in response to an action, such as when two or more objects have been selected, for example. As previously described, the user may be able to configure some of the features with respect to the group mode, so as to effectively give the user a say in, for example, when the group mode is available and/or how it is invoked, if so desired.

As can be further seen in FIG. 1d, once the group mode is enabled, the user can choose the Input Used to Group Objects, which in this example case is selected to be a Downward Swipe from the drop-down menu, as shown. In this particular configuration, the swipe gesture selection of a Downward Swipe to group objects using the group mode may include making a downward swipe gesture after selecting two or more objects, as will be discussed in turn. Other selections for the Input Used to Group Objects may include other swipe-based gestures, such as swipe gestures in different directions (e.g., a rightward or upward swipe gesture), swipe gestures made in certain shapes (e.g., a circular swipe gesture), swipe gestures of certain lengths (e.g., a swipe gesture that spans two or more displayed objects), swipe gestures of certain speeds (e.g., a swipe gesture having a predetermined minimum velocity), or swipe gestures having a certain number or contact points (e.g., using two or more fingers), for example. In still other embodiments, the Input Used to Group Objects may also include other input such as a press-and-hold gesture, a tap gesture on a group button, or a right click menu option (e.g., when using a mouse input device), for example. In this manner, the input used to group objects may vary depending on the group mode's configuration, and may include touch sensitive user input (e.g., various gestures including taps, swipes, press-and-holds, combinations thereof, and/or other such input that is identifiable as Input Used to Group Object) or non-touch sensitive user input. The Configure virtual button may allow for additional configuration of the Input Used to Group Objects settings option. For example, after selecting this corresponding Configure virtual button, the user may be able to configure where the bundle will be located after the objects are grouped (e.g., to the location of the first or last selected object). Numerous different user input characteristics may affect whether the group mode grouping function is invoked, as will be apparent in light of this disclosure.

Continuing with the settings screen shown in FIG. 1d, the user can select the Bundle Representation to set the way that the bundle is shown on the touch sensitive computing device after two or more objects are grouped. As shown selected from the drop-down menu, the Bundle Representation is set as a Stack of Objects, meaning that the bundle will be represented by or displayed as a stack of the objects it contains, as will be apparent in light of this disclosure. Other Bundle Representation options may include a folder (e.g., where a folder is created that contains the grouped objects), a bundle notification (e.g., where the first object selected represents the bundle and a notification such as a + symbol is placed near the object to notify that it is a bundle), or a collage (e.g., where the objects are juxtaposed and/or overlapped in a random fashion), just to provide a few examples. The Configure virtual button may allow for additional configuration of the Bundle Representation settings option. For example, after selecting this corresponding Configure virtual button, the user may be able to configure the default naming method of a bundle when two or more objects are grouped (e.g., the bundle may have no name, be assigned a name automatically, or prompt the user to enter a name after grouping the objects).

Continuing with the settings screen shown in FIG. 1d, three more group mode features are presented under the Other Group Mode Options section. Next to each feature is a check box to enable or disable the option (all three shown in their enabled states). The first of these features is a Group Plus Interaction feature that, when enabled, may allow a user to simultaneously group selected objects into a bundle and invoke an interaction. When enabled, the user may be able to configure how the Group Plus Interaction feature is invoked and/or assign interactions to particular user input using the corresponding Configure virtual button (and/or configure other aspects of the feature). For example, a downward swipe may be assigned to group the objects into a bundle, a leftward swipe may be assigned to group the objects into a bundle and share the bundle, a rightward swipe may be assigned to group the objects into a bundle and email the bundle, and an upward swipe may be assigned to group the objects into a bundle and copy the bundle. In some instances, additional steps may have to be taken to perform the invoked interaction when a Group Plus Interaction swipe gesture is used, such as tapping a confirmation button after a leftward share swipe from the previous example (e.g., to ensure sharing of the bundle was desired). The Group Plus Interaction feature may be configured in any number of ways to invoke an interaction based on a corresponding swipe gesture, and as previously explained, this feature and all other features described herein may be user-configurable, hard-coded, or some combination thereof.

The next feature in the Other Group Mode Features section shown in FIG. 1d is a Select Plus Group feature. When this feature is enabled, the user input used to invoke the group mode may also be used to select the objects desired to be grouped. The user may be able to configure how the Select Plus Group feature is invoked and/or assign a particular user input for the feature (or configure some other aspect of the feature) using the corresponding Configure virtual button. For example the Select Plus Group feature may use a continuous swipe gesture that includes swiping to or around each object desired to be grouped, where the objects are grouped into a bundle when the swipe gesture is released. The next feature in the Other Group Mode Features section is an Ungroup Action feature, which, when enabled, may allow a user to ungroup a previously formed bundle. The user may be able to configure the user input needed for the Ungroup Action feature, such as assigning a particular gesture using the corresponding Configure virtual button. For example, the Ungroup Action feature may include a press-and-hold or an outward spread gesture on the bundle to ungroup the previously formed bundle. Any number of features of the group mode may be configurable, but they may also be hard-coded or some combination thereof, as previously explained. Numerous configurations and features will be apparent in light of this disclosure.

In one or more embodiments, the user may specify a number of applications in which the group mode can be invoked. Such a configuration feature may be helpful, for instance, in a smart phone or tablet computer or other multifunction computing device that can execute different applications (as opposed to a device that is more or less dedicated to a particular application). In one example case, for instance, the available applications could be provided along with a corresponding check box. Example diverse applications include an eBook application, a document editing application, a text or chat messaging application, a browser application, a file manager application, or a media manager application (e.g., a picture or video gallery), to name a few. In other embodiments, the group mode can be invoked whenever two or more objects are selected, such as two or more pictures, videos, or notes, for example. Any number of applications or device functions may benefit from a group mode as provided herein, whether user-configurable or not, and the claimed invention is not intended to be limited to any particular application or set of applications.

As can be further seen in FIG. 1d, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Again, while FIGS. 1c and 1d show user configurability, other embodiments may not allow for any such configuration, wherein the various features provided are hard-coded or otherwise provisioned by default. The degree of hard-coding versus user-configurability can vary from one embodiment to the next, and the claimed invention is not intended to be limited to any particular configuration scheme of any kind

Architecture

FIG. 2a illustrates a block diagram of a touch sensitive computing device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc.). Further note that although a touch screen display is provided, other embodiments may include a non-touch screen and a touch sensitive surface such as a track pad, or a touch sensitive housing configured with one or more acoustic sensors, etc. The principles provided herein equally apply to any such touch sensitive devices. For ease of description, examples are provided with touch screen technology.

The touch sensitive surface (touch sensitive display or touch screen, in this example) can be any device that is configured with user input detecting technologies, whether capacitive, resistive, acoustic, active or passive stylus, and/or other input detecting technology. The screen display can be layered above input sensors, such as a capacitive sensor grid for passive touch-based input (e.g., with a finger or passive stylus in the case of a so-called in-plane switching (IPS) panel), or an electro-magnetic resonance (EMR) sensor grid (e.g., for sensing a resonant circuit of the stylus). In some embodiments, the touch screen display can be configured with a purely capacitive sensor, while in other embodiments the touch screen display may be configured to provide a hybrid mode that allows for both capacitive input and active stylus input. In still other embodiments, the touch screen display may be configured with only an active stylus sensor. In any such embodiments, a touch screen controller may be configured to selectively scan the touch screen display and/or selectively report contacts detected directly on or otherwise sufficiently proximate to (e.g., within a few centimeters) the touch screen display. The proximate contact may include, for example, hovering input used to cause location specific input as though direct contact were being provided on a touch sensitive surface (such as a touch screen). Numerous touch screen display configurations can be implemented using any number of known or proprietary screen based input detecting technology.

Continuing with the example embodiment shown in FIG. 2a, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including a group mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., 800 MHz Texas Instruments® OMAP3621 applications processor), and may include one or more co-processors or controllers to assist in device control. In this example case, the processor receives input from the user, including input from or otherwise derived from the power button, home button, and touch sensitive surface. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory).

The display can be implemented, for example, with a 6-inch E-ink Pearl 800×600 pixel screen with Neonode® zForce® touch screen, or any other suitable display and touch screen interface technology. The communications module can be, for instance, any suitable 802.11 b/g/n WLAN chip or chip set, which allows for connection to a local network so that content can be downloaded to the device from a remote location (e.g., content provider, etc, depending on the application of the display device). In some specific example embodiments, the device housing that contains all the various componentry measures about 6.5″ high by about 5″ wide by about 0.5″ thick, and weighs about 6.9 ounces. Any number of suitable form factors can be used, depending on the target application (e.g., laptop, desktop, mobile phone, etc.). The device may be smaller, for example, for smart phone and tablet applications and larger for smart computer monitor and laptop applications.

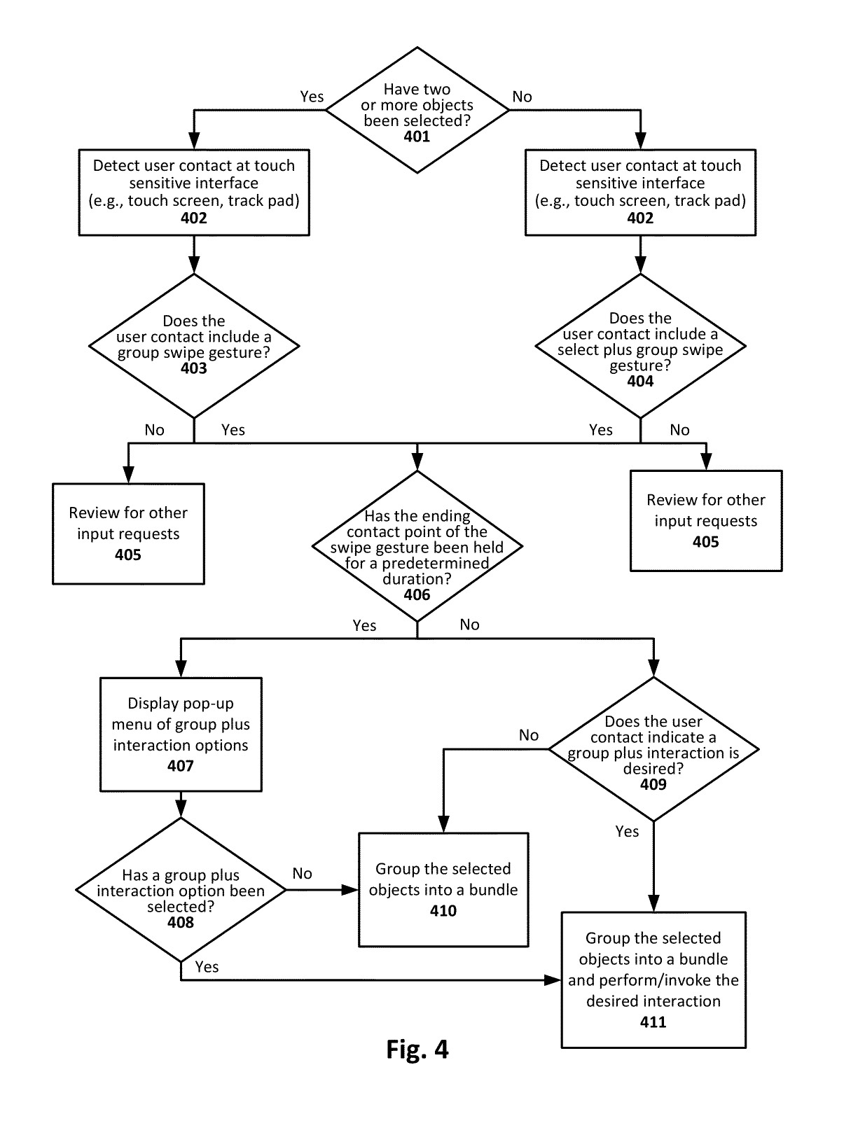

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms, or other suitable platforms. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The user interface (UI) module can be, for example, based on touch screen technology, and the various example screen shots and example use-cases shown in FIGS. 1a, 1c-d, and 3a-g′, in conjunction with the group mode methodologies demonstrated in FIG. 4, which will be discussed in turn. The audio module can be configured, for example, to speak or otherwise aurally present a selected eBook or other textual content, if preferred by the user. In some example cases, if additional space is desired, for example, to store digital books or other content and media, storage can be expanded via a microSD card or other suitable memory expansion technology (e.g., 32 GBytes, or higher).

Client-Server System

FIG. 2b illustrates a block diagram of a communication system including the touch sensitive computing device of FIG. 2a, configured in accordance with an embodiment of the present invention. As can be seen, the system generally includes a touch sensitive computing device that is capable of communicating with a server via a network/cloud. In this example embodiment, the touch sensitive computing device may be, for example, an eReader, a mobile phone, a smart phone, a laptop, a tablet, a desktop computer, or any other touch sensitive computing device. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by providing the user with requested or otherwise recommended content. In some such embodiments, the server may be configured to remotely provision a group mode as provided herein to the touch sensitive device (e.g., via JavaScript or other browser based technology). In other embodiments, portions of the methodology may be executed on the server and other portions of the methodology may be executed on the device. Numerous server-side/client-side execution schemes can be implemented to facilitate a group mode in accordance with one or more embodiments, as will be apparent in light of this disclosure.

### Example Group Mode Functions

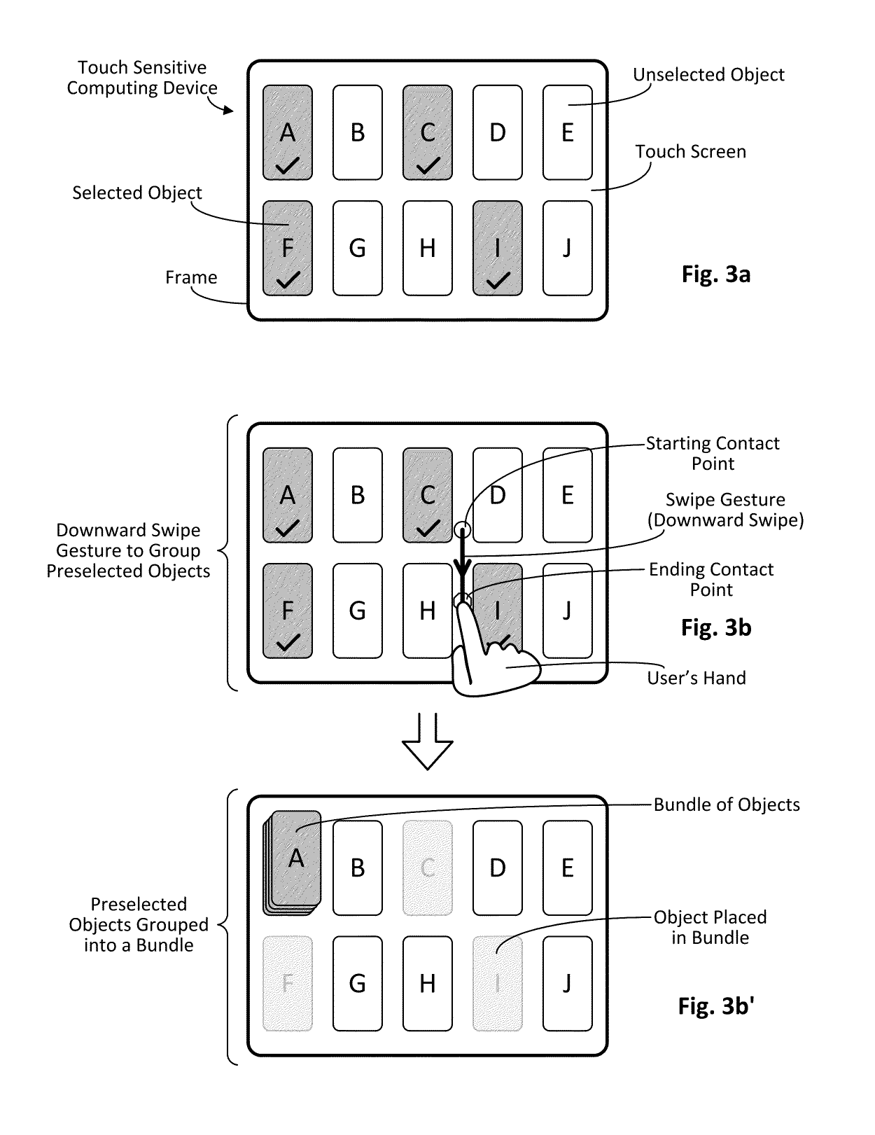

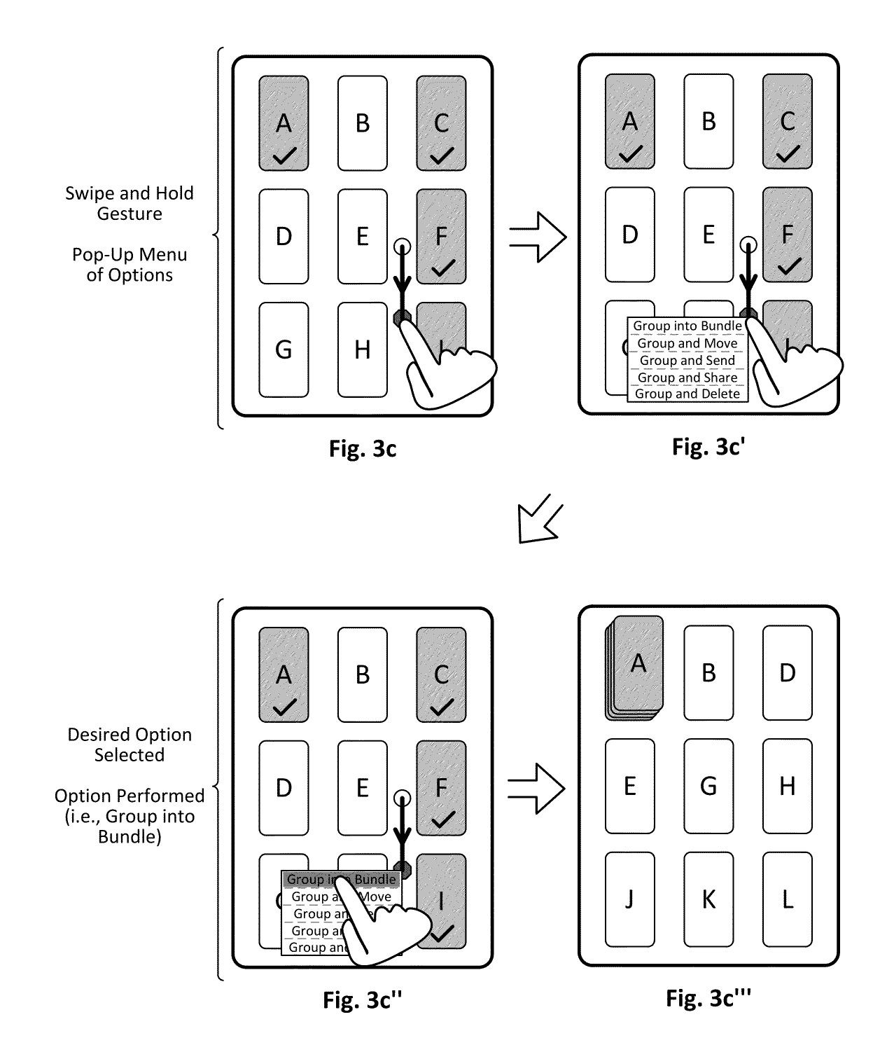

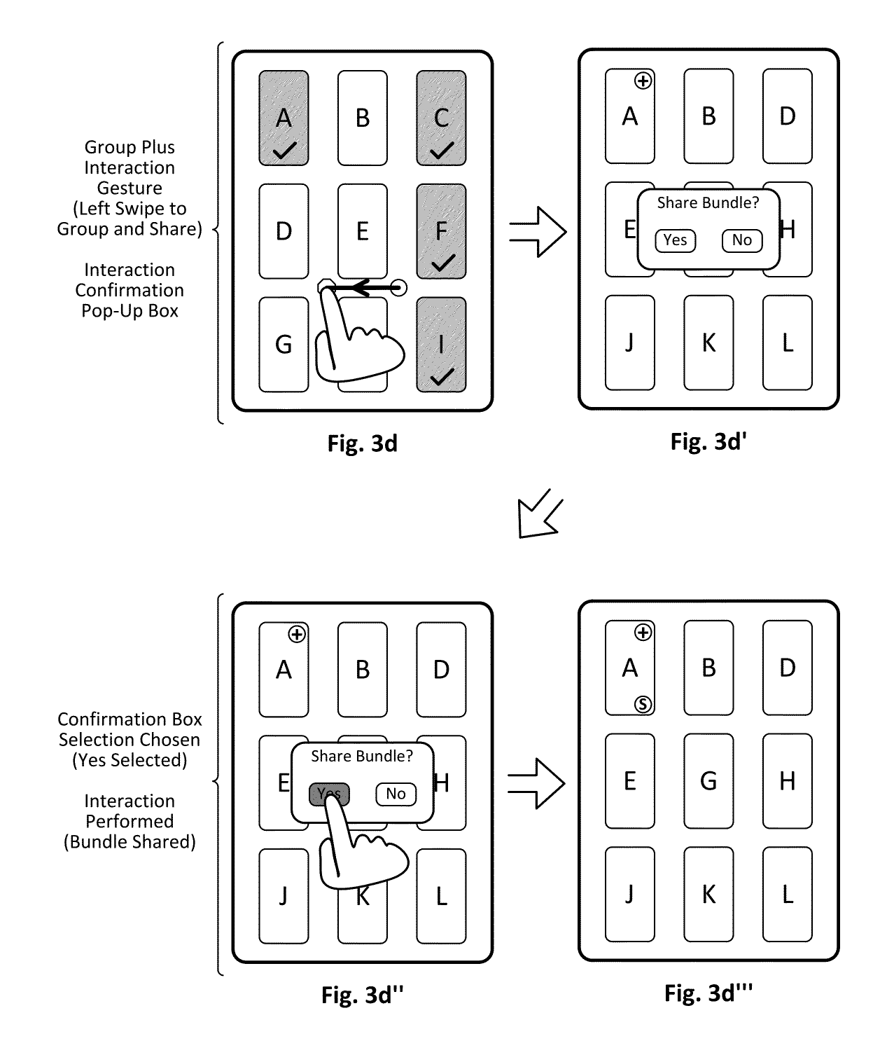

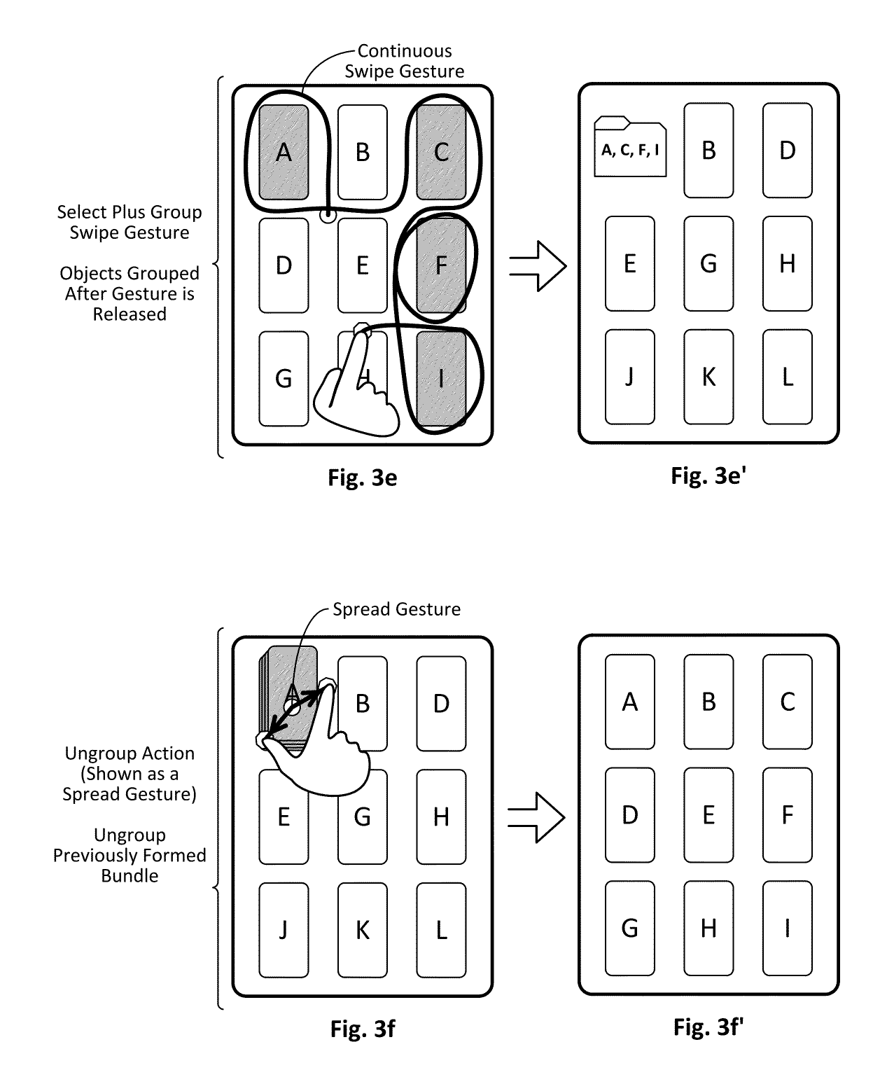

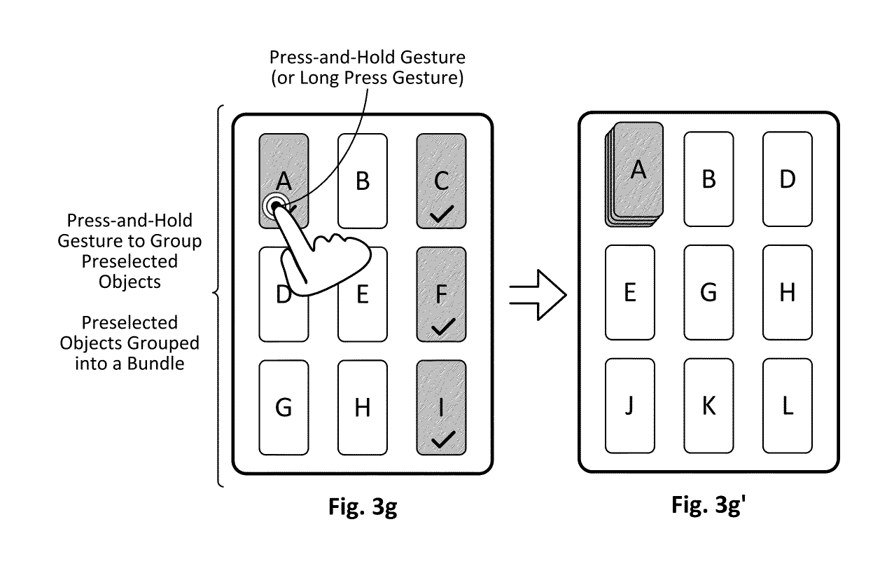

FIG. 3a illustrates a screen shot of an example computing device having a group mode configured in accordance with one or more embodiments of the present invention. As previously explained, the group mode may be configured to run on non-touch sensitive devices, where the user input may be provided using a physical keyboard and a mouse, for example. For ease of description, example group mode functions are discussed herein in the context of a touch sensitive computing device. Continuing with FIG. 3a, the touch sensitive computing device includes a frame that houses a touch sensitive surface, which in this example, is a touch screen display. In some embodiments, the touch sensitive surface may be separate from the display, such as is the case with a track pad. As previously described, any touch sensitive surface for receiving user input (e.g., via direct contact or hovering input) may be used for the group mode user input as variously described herein, such as swipe gestures, spread gestures, and press-and-hold gestures. The gestures may be made by a user's hand(s) and/or by one or more implements (such as a stylus or pen), for example. The group mode gestures and resulting functions variously illustrated in FIGS. 3b-g′ and described herein are provided for illustrative purposes only and are not exhaustive of all possible group mode user input and/or functions, and thus are not intended to limit the claimed invention.

As will be apparent in light of this disclosure, the group mode can be used to group two or more selected objects into a bundle using user input (e.g., user contact such as a gesture) to allow for interactions with the bundle. As previously described the user input may include a swipe gesture (e.g., as will be discussed in reference to FIGS. 3b-b′), a press-and-hold gesture (e.g., as will be discussed in reference to FIGS. 3g-g′), or some other user input (whether from a touch sensitive surface/interface or from a non-touch sensitive input device). In some embodiments, the group mode may include invoking an interaction to be performed on the bundle, as will be discussed in reference to FIGS. 3c-3d′″ and referred to herein as a group plus interaction gesture. In some embodiments, the group mode may include the selection of the objects desired to be grouped into a bundle, as will be discussed in reference to FIGS. 3e-e′ and referred to herein as a select plus group gesture. In some embodiments, the group mode may include both selection of the objects desired to be grouped into a bundle and invocation of an interaction to be performed on the bundle. In some embodiments, the group mode may include an ungroup action or user input to ungroup a previously formed bundle, such as is discussed in reference to FIGS. 3f-f′.

Continuing with the screen shot shown in FIG. 3a, ten objects are shown (objects A-J), where the objects may include any number of various objects, such as photos, videos, documents, etc. As shown, four of the objects have been preselected (i.e., objects A, C, F, and I). The objects may have been preselected using any number of techniques, such as by tapping a select objects button (not shown) to invoke the ability to select desired objects using an appropriately placed tap on each object desired to be selected, for example. Based on this example technique, the user may have pressed the select objects button and then performed a tap gesture on objects A, C, F, and I to cause them to be selected. This is indicated by each object being highlighted and having a check mark inside and at the bottom of the object. For completeness of description, the remaining objects shown in this screen shot are unselected (i.e., objects B, D, E, G, H, and J).

FIGS. 3b-b′ illustrate an example user input used to group preselected objects into a bundle, in accordance with an embodiment of the present invention. As shown in FIG. 3b, a swipe gesture is being made by the user's hand (specifically, the user's right index finger) to group the preselected objects into a bundle, the result of which is shown in FIG. 3b′. The swipe gesture is shown as a downward swipe (where the direction of the swipe is indicated by an arrow) with a starting contact point (indicated by the white circle) and an ending contact point (indicated by the white octagon). As previously described, the group mode may use various user input to group two or more preselected objects into a bundle and the user input that invokes the group mode may be based on the user's preferences (e.g., where the group mode user input is user-configurable), automatic (e.g., where the group mode user input is hard-coded), or some combination thereof. Various characteristics of the user input may affect whether a group mode group function is invoked. In the example shown in FIG. 3b, various characteristics of the swipe gesture may affect whether the group mode is invoked, such as the direction, length, speed, starting contact point(s) location, ending contact point(s) location, and/or number of contacts of the swipe gesture. For example, after one or more objects have been selected, the user may use a one-fingered swipe gesture to pan the display to show different objects for selection, and use a two-fingered swipe gestures to invoke the group mode group function to group two or more preselected objects into a bundle.

After the appropriate group mode user input is made to group the preselected objects (e.g., a downward swipe gesture in the case of FIG. 3b), the preselected objects can be grouped into a bundle as illustrated in the example screen shot shown in FIG. 3b′. In this specific example, the preselected objects were grouped into a bundle in the position of object A. The position of the resultant bundle may be determined by various factors, such as which object was selected first or last, or the starting or ending contact point(s) of the swipe gesture, for example. In this example case, after the preselected objects are placed into the bundle, the objects are automatically removed from their pre-bundle location (as indicated by the faint remains of objects C, F, and I). In some instances, after the group function is performed and the preselected objects are placed into a bundle, the unselected objects (i.e., objects B, D, E, G, H, and J in this example) may move to fill in the objects that were grouped into a bundle (as illustrated in FIG. 3c′″). Although the bundle of objects illustrated in FIG. 3b′ is shown as a stack of all of the objects that are in the bundle, the bundle may be represented in various different ways, as described herein.

After the objects have been grouped into a bundle, the user may interact with the bundle in various different ways, as will be apparent in light of this disclosure. For example, the user may edit, organize, and/or share the bundle as desired. More specific examples may include moving the bundle to another location (e.g., by dragging the bundle to the desired location), sending the bundle via an email or messaging service, and/or sharing the bundle to allow access to it from other users, just to name a few specific examples. This allows the user to perform interactions to a group of objects simultaneously while keeping the objects grouped together. In some embodiments, once an interaction is performed on a bundle, the bundle may be ungrouped. For example, in some such embodiments, after a bundle of objects is moved from a first location to a second location (e.g., using a drag-and-drop gesture), the objects in the bundle may ungroup automatically, i.e., after moving them to the second location.

FIGS. 3c-c′″ illustrate an example group mode configuration where holding user input used to group objects performs an action, in accordance with an embodiment of the present invention. FIGS. 3c-c′″ show the touch sensitive computing device of FIG. 3a in a vertical or portrait orientation. In this example, the user input is a swipe gesture, which is held to perform an action. More specifically, FIG. 3c shows a downward swipe and hold gesture that causes a pop-up menu of options to be displayed as shown in FIG. 3c′. The swipe and hold gesture can be invoked by holding the ending contact point of the swipe gesture for a predetermined duration (e.g., 1-2 seconds or some other suitable duration), which may be user-configurable or hard-coded. After the swipe and hold gesture is performed, a hold action may be invoked, such as displaying the pop-up menu of options as shown in FIG. 3c′. The group mode swipe and hold gesture may cause some other action (such as invoking a particular interaction), which may be user-configurable or hard-coded. Continuing with FIG. 3c″, since the swipe and hold gesture action in this example causes a pop-up menu of options to be displayed, the user can then select one of the pop-up menu options. Selection may be achieved by swiping to the desired option while maintaining contact after the swipe and hold gesture and releasing to select the option or tapping on the desired selection, for example. In this specific example, the user chose the Group into Bundle option, which caused the preselected objects (i.e., A, C, F, and I) to be grouped into a bundle as shown in FIG. 3c′″.

FIGS. 3d-d′″ illustrate an example used input used to group preselected objects into a bundle and perform an interaction on the bundle, in accordance with an embodiment of the present invention. FIG. 3d shows a leftward swipe gesture being used to cause the preselected objects (i.e., A, C, F, and I) to be grouped and shared in this specific example. As previously described, the characteristics of the group mode user input (e.g., swipe gesture in this example) may affect the function performed. For example, the direction of the swipe gesture in this example may determine whether to group preselected objects into a bundle, or to group preselected objects into a bundle and invoke a bundle interaction. As previously described, the functions assigned to various group mode swipe gestures may be user-configurable, hard-coded, or some combination thereof. Continuing with FIG. 3d′, after the leftward swipe gesture in FIG. 3d was performed, the preselected objects were grouped into a bundle as indicated by a “+” inside of a circle in the top right corner of object A (the representative object for the bundle). However, as previously described, the bundle may be represented in various different ways (e.g., as a stack as shown in FIGS. 3b′ and 3c′″ or as a folder as shown in FIG. 3e′). An interaction confirmation pop-up box was also displayed in this example embodiment to provide an additional step before performing the interaction, ensuring the user desired to perform the invoked interaction. In other embodiments, the interaction may be automatically performed after group plus interaction user input is provided. FIG. 3d″ shows the user selecting the Yes option in the confirmation box to perform the interaction (i.e., to share the bundle). The result of the Yes selection is shown in FIG. 3d′″, where the bundle is shared (as indicated by an “S” inside of a circle in the bottom right corner of bundle A) to allow other users to access the bundle (e.g., via a shared content portion of a local or wide-area network).

FIGS. 3e-e′ illustrate an example user input used to select objects and group the selected objects into a bundle, in accordance with an embodiment of the present invention. As previously described, the user may preselect objects desired to be grouped using the group mode (e.g., as was the case with FIGS. 3a-3d′″) or the objects may be selected and grouped using the same user input. In the example select plus group function in FIGS. 3e-e′, a continuous swipe gesture is being used in FIG. 3e to select which objects are to be grouped when the swipe gesture is released. In this particular configuration, the select plus group function is configured to select items if they have been circled or substantially circled using the continuous swipe gesture as shown. However, various different techniques may be used to select objects using select plus group user input, such as swiping to the center of the object to select it, to name another example. Objects A, C, F, and I were selected using a select plus group swipe gesture as shown in FIG. 3e. After the swipe gesture was released (at the ending contact point indicated by the octagon), the selected objects (i.e., A, C, F, and I) were grouped into a bundle as shown in FIG. 3e′.

FIGS. 3f-f′ illustrate an example user input used to ungroup a previously formed bundle, in accordance with an embodiment of the present invention. As previously described, once a bundle has been formed, the user may desire to ungroup the bundle and separate the objects contained therein. Therefore, in some embodiments, an ungroup action or user input may be used to ungroup a previously formed bundle the bundle. The example ungroup action shown in FIG. 3f is being used to completely ungroup the A, C, F, I bundle formed in FIGS. 3b-b′. In this specific example, the quick ungroup action or user input is a spread gesture, which was used to completely ungroup the A, C, F, I bundle, the result of which is shown in FIG. 3f. Various different actions or user input could be used for the ungroup action, such as a press-and-hold on the bundle, to name another example.

FIGS. 3g-g′ illustrate an example user input used to group preselected objects into a bundle, in accordance with an embodiment of the present invention. FIGS. 3g-g′ show the touch sensitive computing device of FIG. 3a in a vertical or portrait orientation. As shown in FIG. 3g, a press-and-hold gesture (or long press gesture) is being made by the user's hand (specifically, the user's right index finger) to group the preselected objects into a bundle, the result of which is shown in FIG. 3g′. As previously described, various different user input (or user contact in the case of a touch sensitive computing device) may be used to invoke the group mode to group multiple selected objects into a bundle. The example user input used to invoke the group mode shown in FIGS. 3b and 3g are provided for illustrative purposes and are not intended to limit the claimed invention. Numerous different group mode functions and configurations will be apparent in light of this disclosure.

Methodology

FIG. 4 illustrates a method for providing a group mode in a computing device, in accordance with one or more embodiments of the present invention. As previously described, non-touch sensitive devices may implement a group mode method as variously described herein. For ease of description, the group mode methodology illustrated in FIG. 4 is discussed herein in the context of a touch sensitive computing device. This example methodology may be implemented, for instance, by the UI module of, for example, the touch sensitive computing device shown in FIG. 2a, or the touch sensitive device shown in FIG. 2b (e.g., with the UI provisioned to the client by the server). To this end, the UI can be implemented in software, hardware, firmware, or any combination thereof, as will be appreciated in light of this disclosure.

The method generally includes sensing a user's input by a touch sensitive surface. In general, any touch sensitive device may be used to detect contact (whether direct or proximate) with it by one or more fingers and/or styluses or other suitable implements. As soon as the user begins to drag or otherwise move the contact point(s) (i.e., starting contact point(s)), the UI code (and/or hardware) can assume a swipe gesture has been engaged and track the path of each contact point with respect to any fixed point within the touch surface until the user stops engaging the touch sensitive surface. The release point can also be captured by the UI as it may be used to execute or stop executing (e.g., in the case of selecting objects using a select plus group swipe gesture) the action started when the user pressed on the touch sensitive surface. In this manner, the UI can determine if a contact point is being held to determine, for example if a swipe and hold gesture or a press-and-hold gesture (or long press gesture) is being performed, for example. These main detections can be used in various ways to implement UI functionality, including a group mode as variously described herein, as will be appreciated in light of this disclosure.

The example method illustrated in FIG. 4 and described herein is in the context of using a swipe gesture to invoke the group mode. However, as previously described, various different user input (or user contact) may be used to invoke the group mode, such as a press-and-hold, a tap gesture on a group button, or a right click menu option (e.g., when using a mouse input device). In the example case shown in FIG. 4, the method includes determining 401 if two or more objects have been selected. As previously described, objects may include files, pictures, video content, audio content, books, drawings, messages, notes, documents, presentations or lectures, pages, folders, icons, textual passages, bookmarks, calendar events, contacts, applications, services, and configuration settings, just to name a few example object types. Regardless of whether two or more objects have been selected, the method continues by detecting 402 user contact (whether direct or proximate) at the touch sensitive interface (e.g., touch screen, track pad, etc.). If two or more objects have been selected (e.g., as shown in FIG. 3a), then the method continues by determining 403 if the user contact includes a group swipe gesture as variously described herein. As previously described, numerous different swipe gestures may be used to invoke a group mode to group two or more selected objects into a bundle. In addition, swipe gestures that cause invocation of the group mode to group two or more selected objects into a bundle may be user-configurable, hard-coded, or some combination thereof. If two or more objects have not been selected, then the method continues by determining 404 if the user contact includes a select plus group swipe gesture as variously described herein. For example, if selecting objects using a select plus group swipe gesture includes swiping around them (e.g., as shown in FIG. 3e), it may be determined that the user contact includes a select plus group swipe gesture when two or more objects have been swiped around.

If the user contact does not include a group swipe gesture or a select plus group swipe gesture, then the method continues by reviewing 405 for other input requests. If the user contact includes either a group swipe gesture or a select plus group swipe gesture, then the method continues by determining 406 if the ending contact point of the swipe gesture has been held for a predetermined duration (i.e., has swipe and hold been invoked). As previously described, the predetermined duration for holding the ending contact point of a group swipe and hold gesture may be 1-2 seconds, or some other suitable duration. The predetermined duration may be user-configurable, hard-coded, or some combination thereof. If the ending contact point of the swipe gesture (either the group swipe gesture or the select plus group swipe gesture) has been held for the predetermined duration, then the method continues by displaying 407 a pop-up menu of group plus interaction options (e.g., as shown in FIG. 3c′). The swipe and hold gesture may be used to invoke a different action (other than displaying a pop-up menu), such as causing a specific group plus interaction, for example. The options may include various functions, such as group and move the selected objects, group and send the selected objects, group and share the selected objects, or group and delete the selected objects. In some cases, the options may include the function of grouping the selected objects into a bundle without performing or invoking an additional interaction (e.g., the Group into Bundle option shown in FIG. 3c′). The method continues by determining 408 if a group plus interaction option has been selected.

Continuing from 406, if the ending contact point of the swipe gesture has not been held for a predetermined duration, the method determines 409 if the user contact indicates a group plus interaction is desired. As previously described, the characteristics of group mode swipe gestures may affect the function performed. For example, the direction of group mode swipe gestures may determine if grouping the selected objects is desired or if a group plus interaction is desired. The function performed by various group mode swipe gestures may be user-configurable, hard-coded, or some combination thereof. Continuing from 408 and 409, if a group plus interaction has not been selected (e.g., from 408) or indicated with user contact (e.g., from 409), then the method continues by grouping 410 the selected objects into a bundle. If a group plus interaction is desired (as indicated by a group plus interaction option selection from 408 or an appropriate group plus interaction swipe gesture from 409), then the method groups 411 the selected objects into a bundle and performs and/or invokes the desired interaction.

After the grouping (or group plus interaction) has been performed in response to a group mode swipe gesture, the method may continue by reviewing for other input requests. For example, the UI may review for user contact invoking an interaction (or additional interactions) with the bundle after the selected objects were grouped (or grouped and interacted with). As previously indicated, the group mode may be application specific, such that it is only available, enabled, and/or active when applications that use the group mode are available, enabled, and/or active. In addition, the group mode may only be available, enabled, and/or active when two or more objects have been selected. In this manner, power and/or memory may be conserved since the group mode may only run or otherwise be available when a specific application is running or otherwise available, or when two or more objects have been selected.

Numerous variations and embodiments will be apparent in light of this disclosure. One example embodiment of the present invention provides a device including a display for displaying content to a user, a touch sensitive interface for allowing user input, and a user interface. The user interface includes a group mode that can be invoked in response to user input via the touch sensitive interface, wherein the group mode is configured to group a plurality of selected objects into a bundle. In some cases, the display is a touch screen display that includes the touch sensitive surface. In some cases, the plurality of selected objects are selected prior to invoking the group mode. In some cases, the user input includes a swipe gesture. In some such cases, the swipe gesture is used to select a plurality of objects and group them into a bundle. In some cases the user input includes a press-and-hold gesture. In some cases, the plurality of objects includes at least one of a file, a picture, video content, audio content, a book, a drawing, a message, a note, a document, a presentation, a lecture, a page, a folder, an icon, a textual passage, a bookmark, a calendar event, a contact, an application, a service, a configuration setting, and a previously formed bundle. In some cases, the group mode is user-configurable.

Another example embodiment of the present invention provides a mobile computing device including a display having a touch screen interface and for displaying content to a user, and a user interface. The user interface includes a group mode that can be invoked in response to user input via the touch sensitive interface (the user input including at least one of a swipe gesture and a press-and-hold gesture), wherein the group mode is configured to group a plurality of selected objects into a bundle. In some cases, user input is used to group the plurality of selected objects into a bundle and to perform an interaction on the bundle. In some such cases the interaction includes one of sending, sharing, moving, organizing, editing, converting, copying, cutting, deleting, and opening the bundle. In some cases, holding the user input for a predetermined duration causes a pop-up menu of selectable options. In some cases, the group mode includes an ungroup action that can be used to ungroup a previously formed bundle.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to invoke a group mode in a device capable of displaying content in response to user input via a touch sensitive interface of the device (wherein the group mode is configured to group a plurality of selected objects into a bundle), and group the plurality of selected objects into a bundle. In some cases, the plurality of selected objects are selected prior to invoking the group mode. In some cases, the user contact includes a swipe gesture. In some cases, the user contact includes a press-and-hold gesture. In some cases, the plurality of objects includes at least one of a file, a picture, video content, audio content, a book, a drawing, a message, a note, a document, a presentation, a lecture, a page, a folder, an icon, a textual passage, a bookmark, a calendar event, a contact, an application, a service, a configuration setting, and a previously formed bundle. In some cases, the process is configured to perform an interaction on the bundle in response to the user input. In some cases, the process is configured to perform an interaction on the bundle in response to additional user input.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a display for displaying content to a user;
a touch sensitive interface for allowing user input; and
a user interface including a group mode that can be invoked in response to user input via the touch sensitive interface, wherein the group mode is configured to group a plurality of selected objects into a bundle.

2. The device of claim 1 wherein the display is a touch screen display that includes the touch sensitive surface.

3. The device of claim 1 wherein the plurality of selected objects are selected prior to invoking the group mode.

4. The device of claim 1 wherein the user input includes a swipe gesture.

5. The device of claim 4 wherein the swipe gesture is used to select a plurality of objects and group them into a bundle.

6. The device of claim 1 wherein the user input includes a press-and-hold gesture.

7. The device of claim 1 wherein the plurality of objects includes at least one of a file, a picture, video content, audio content, a book, a drawing, a message, a note, a document, a presentation, a lecture, a page, a folder, an icon, a textual passage, a bookmark, a calendar event, a contact, an application, a service, a configuration setting, and a previously formed bundle.

8. The device of claim 1 wherein the group mode is user-configurable.

9. A mobile computing device, comprising:
a display having a touch screen interface and for displaying content to a user; and
a user interface including a group mode that can be invoked in response to user input via the touch sensitive interface, the user input including at least one of a swipe gesture and a press-and-hold gesture, wherein the group mode is configured to group a plurality of selected objects into a bundle.

10. The device of claim 9 wherein the user input is used to group the plurality of selected objects into a bundle and to perform an interaction on the bundle.

11. The device of claim 10 wherein the interaction includes one of sending, sharing, moving, organizing, editing, converting, copying, cutting, deleting, and opening the bundle.

12. The device of claim 9 wherein holding the user input for a predetermined duration causes a pop-up menu of selectable options.

13. The device of claim 9 wherein the group mode includes an ungroup action that can be used to ungroup a previously formed bundle.

14. A computer program product comprising a plurality of instructions non-transiently encoded thereon to facilitate operation of an electronic device according to the following process, the process comprising:
in response to user input via a touch sensitive interface of a device capable of displaying content, invoke a group mode in the device, wherein the group mode is configured to group a plurality of selected objects into a bundle; and
group the plurality of selected objects into a bundle.

15. The computer program product of claim 14 wherein the plurality of selected objects are selected prior to invoking the group mode.

16. The computer program product of claim 14 wherein the user contact includes a swipe gesture.

17. The computer program product of claim 14 wherein the user contact includes a press-and-hold gesture.

18. The computer program product of claim 14 wherein the plurality of objects includes at least one of a file, a picture, video content, audio content, a book, a drawing, a message, a note, a document, a presentation, a lecture, a page, a folder, an icon, a textual passage, a bookmark, a calendar event, a contact, an application, a service, a configuration setting, and a previously formed bundle.

19. The computer program product of claim 14 wherein the process further comprises:
perform an interaction on the bundle in response to the user input.

20. The computer program product of claim 14 wherein the process further comprises:
perform an interaction on the bundle in response to additional user input.
